(19) United States
(12) Patent Application Publication
(10) Pub. No.: US 2011/0035809 A1
(43) Pub. Date: Feb. 10, 2011

(54) AGENT SERVICE

(76) Inventor: Frederick C. Fisher, Normandy Park, WA (US)

Correspondence Address: OLYMPIC PATENT WORKS PLLC, P.O. BOX 4277, SEATTLE, WA, 98104, US

(21) Appl. No.: 12/853,506

(22) Filed: Aug. 10, 2010

Related U.S. Application Data
(60) Provisional application No. 61/232,535, filed on Aug. 10, 2009.

(51) Int. Cl. H04L 9/00

(52) U.S. Cl. 726/27

(57) ABSTRACT

One embodiment of the present invention is directed to a method for compressing data generated by multiple data sources. The method includes steps of partitioning data generated by the multiple data sources into data partitions, the data included in each data partition containing inter-data-source redundancies and, for each data partition, compressing the data in the data partition to remove the inter-data-source redundancies.

### CROSS-REFERENCE TO RELATED APPLICATION

This application claims the benefit, of Provisional Application No. 61/232,535 filed Aug. 10, 2009.

### TECHNICAL FIELD

The present invention is related to electronic communications and, in particular, a method and system controlling information distribution through electronic communications.

### BACKGROUND

With the advent of email, electronic commerce, and Internet-enabled social networking and other Internet-based information-exchange media, an ever increasing amount of valuable personal and organizational information is being distributed through many different communities of users. Increasingly, such information is being captured and used for purposes unintended by those who provide the information through electronic-communications media. In many cases, the unintended uses of information may represent merely an annoyance to information providers, but, in many other cases, the information may be used maliciously or dishonestly, to the detriment of the information providers.

### SUMMARY

One embodiment, of the present invention comprises an agent service, implemented as an autonomous software application, that establishes and maintains trusted connections and that differentially controls access to digital property. The agent-service embodiment of the present invention may be implemented as a single-user application that hosts information owned by the user and provides controlled, differential, autonomous access to others on a continuous basis, whether or not the user is logged into the agent service. Access to information is either through bi-directionally authenticated connections, such as agent connections, or by validating requests. The method of validating requests ensures, that the requester can approve or prevent any validation. The agent service can also be used to request and receive information either under direct control of the user or autonomously.

### BRIEF DESCRIPTION OF THE DRAWINGS

FIG. 1 shows an agent service comprising four main components, or managers

FIG. 2 shows a user interface that provides data definition, input, and access control configuration.

FIG. 3 shows accessibility of various types of information.

FIG. 4 shows how connections are associated to their relationships in the user interface.

FIG. 5 shows how invitations are used to change the relationship or add a new one.

FIG. 6 illustrates the introduction process.

FIG. 7 illustrates a ternary connection.

### DETAILED DESCRIPTION

For nearly every entity, there is information that should or can be available to others, but not to everyone. An agent service, according to one embodiment, of the present invention, provides access to the owner's information by hosting it with a software service that is available 24 hours a day, 7 days a week, like a web site, but only communicates with known, trusted sources. Instead of requiring every source of a request to create a user name and password, known, trusted sources are established by either making a permanent, secure, bidirectional connection to another application or autonomously validating requests.

The ability to receive information and requests from know sources, even when not online, provides more efficient communications. Communications from unknown sources are eliminated and individuals can use the same secure communication pathway for email, chat, texting, voice, and video communications. Privacy is increased because there is no third party relaying, storing, or providing connectivity, A third party can change and interpret privacy agreements without the information owner's approval. A third patty increases the risk of inadvertently disclosing the owner's information. A third party has access to the activities of the users of its service, including connections, behaviors, and often the contents of communications using the service. Flexibility is increased because the agent-service user can add capabilities to the agent and organize incoming information independently of other agent services. The user is not limited to the options and interfaces offered by a service provider or add-on applications approved by a service provider.

In one embodiment of the present invention, an agent service is a software application that hosts information owned by a single user. The single user may be an individual, organization, or other entity that desires to control access to information. Information, is stored in a repository that only the user has direct access to. Once created, the agent service provides autonomous access to the user's information according to how the user has configured the Agent independent of whether the user is logged into the agent service. Access to subsets of information is granted to trusted agent connections and verifiable requests. The agent connection is a bi-directionally authenticated, secure, portable connection between two online applications that is not dependent on a third party for communications. Verifiable Requests are accomplished via a web of provenance, which is a three-way communication for the purpose of providing validation by a third party of a claim made by one party to another, but only with the permission of the claimant. Configuring the agent service to control access by others to data in the repository is accomplished, according to one embodiment of the present invention, by indexing the information based upon groups or individuals. Each group or individual has a view of the data based upon the indexes set by the user of the agent service.

Access by authenticated, or verifiable sources to the data hosted by the agent service is accomplished, according to one embodiment of the present invention, by sending a message to the agent service containing a request to a specific piece of data or all data contained in a classification or aggregation of data. The request is responded to with all data that meets the request and that can be accessed by the views assigned to the individual that is making the request or group or groups the individual is part of. Other requests, for data can be made, such as notifications of changes or updates to specific pieces of data.

The agent service can also be used to log into websites that require user names and passwords, so the agent service's owner does not have to keep track of them. The agent service can be used as a proxy to explore the web and log into websites, thus providing an additional level of security, privacy, and functionality than is available today. The user can use the agent service to request information from other agent services and other information sources. The agent services can act as a trusted connection to other agent services via agent connections and make queries of information from other agent services and subscribe to updates.

The agent service cats, according to one embodiment of the present invention, be configured to request and receive information only from approved sources and store that information until the user is able to log into the agent service and view the received information, information received may be from other agent services or from, non-agent connections in the form of data feeds, or messages and updates from sources connected to the agent service via agent connections. Use of agent, connections and a method of verification called the “web of provenance” allow agent services to provide information based upon qualifications independent of the an individual's or entity's identity. In other words, the agent service can interact in a verified-anonymous manner.

An agent connection provides an authenticated, secure connection, which is defined, according to one embodiment of the present invention, as identity authentication of the sender and inability of a third party to read the message sent. In the agent connection, the identity assured is another application with access to the connection information. Thus the sensitivity of information each party is willing to transmit through a connection is the lowest common denominator of the level of trust each has for the other party and the confidence that the other party has exclusive control of the connection information, according to one embodiment of the present invention.

The agent connection affords several advantages, such as an ability to create a connection that is unique but anonymous to both ends of the connection, an ability to move to different hosts and implementations without having to reestablish connections, and independence from intermediaries to transmit and store messages and other communications. A minimal scope of authentication includes, according to one embodiment of the present invention, the ability to reliably identify an application with access to the connection information. A minimal connection information allows two applications to securely connect over the Internet using HTTP. Other networks and protocols can be supported as well with additional information stored and a supporting application implementation.

In most cases, agent connections employ a commonly trusted third party to initiate the connection. The function of the third party is to provide authentication assurance and securely communicate secrets between two applications setting up an agent connection. This third party is not involved in any communication after the agent connection has been successfully established.

A method of verifying claims made by another online application, according to one embodiment of the present invention, allows for a claimant to reference a third party authority that holds evidence to support the claim. The third party will not supply the evidence to support the claim to a party wishing to check the claim unless the claimant approves the check. This method of verification can be extended to support multiple sources for evidence of a claim and evidence to support the authority providing evidence.

This method of providing evidence of claims is termed “the web of provenance-” The minimum requirements for a web of provenance, according to one embodiment of the present invention, is a bidirectional secure communication between the claimant and the entity providing validation, hereafter referred to as a “customer service,” and the ability to establish a unidirectional secure communication between the claimant and recipient and another unidirectional connection between the recipient of the claim and the customer service. A bidirectional secure connection between the claimant and customer service ensures the identity of each application to the other and prevents man-in-the-middle attacks. An example of a bidirectional secure connection is an agent connection. The unidirectional secure connection between the claimant and recipient of the claim must ensure that the claimant is making the claim to a valid recipient. The unidirectional secure connection between the recipient and the customer service ensures that the receiver of the claim is able to authenticate the identity of the customer service. An example of a unidirectional secure connection is one created when an online application obtains a certificate from a certificate authority used by many public key infrastructure, schemes. The web of provenance can be used for verifying identity or any other claim made by an online application.

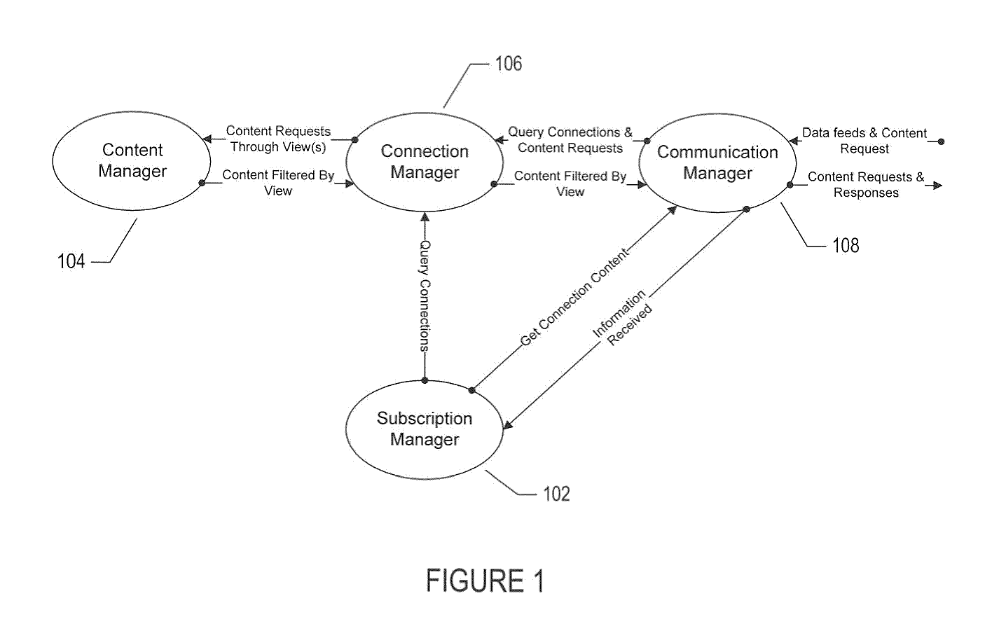

An agent service is comprising four main components, or managers as shown in FIG. 1: subscription manager 102, content manager 104, connection manager 106, and communication manager 108. The subscription manager requests, stores, and manages information from other online applications and messages between, the agent service and other agent services. The subscription manager consists of a temporary data store for information received from other agent services, a persistent data store for storing messages and other public or purchased content; and a user interface for requesting information and viewing responses, according to one embodiment of the present, invention. Where the connection is another agent, the subscription manager can be used to select a connection and request all or a subset of information the connection is known to have. The user selects an agent connection, and requests either specific elements, all data in one or more segments, or all content. Optionally, where provided by the connection, the subscription manager can subscribe to changes in all or a subset of data provided by a connection. The get-connection-data function call consists of the contact id, a set of elements and/or segments, and optionally a flag to receive ongoing updates to elements indicated, information received from other agent services is stored in temporary storage and deleted once the user has viewed the data. If the user is not logged into the agent service when the information is received, then the information is kept in temporary storage. Were the agent service to be restarted for some reason, the request could be resent, since the data belongs to another agent service's user and is available at the discretion of the other agent service's user. Where the connection is a website or other data feed, the subscription manager cm be used to store and display broadcasts, posts, or other data feeds and store in either temporary or permanent storage. For example, the subscription manager can store Really Simple Syndication (RSS) feeds received from connections.

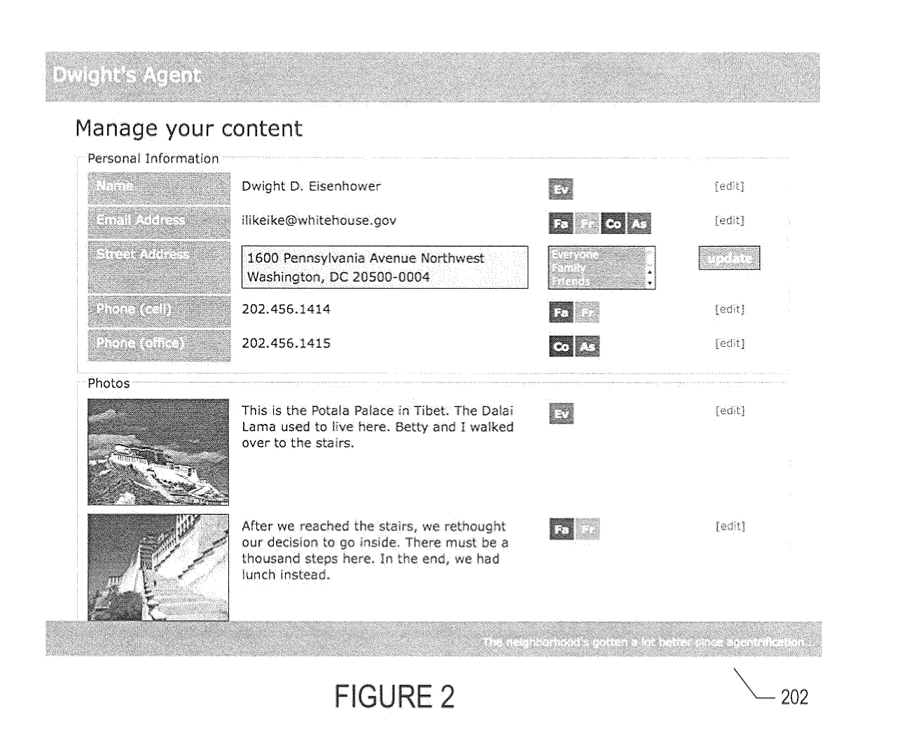

The content manager is a data store with a user interface and an application interface. The user interface is accessible, according to one embodiment of the present invention, only to the owner of the agent service. The user interface provides data definition, input, and access control configuration, as shown in the screen shot 202 in FIG. 2. The application interface provides a means to request and receive data managed by the content manager. The request-for-content call employs one or more views, called “relationships,” to indicate which subset(s) of the content should be returned with the request. Content is supplied to requests as an XML document. If a call is made with no or an invalid view indicated, then no data is returned. The content is composed of elements and each element's description. Elements are grouped into segments. The user can enter data into pre-defined elements or create new elements and segments to enter data into. The user can assign one or more relationships to elements or segments. The relationships act as indexes to create views of the data. A view is the content and description of all elements that have been assigned to a specific relationship. The functionality of the content manager is similar to that, found in many content management systems (CMS). An application interface accepts the following function call from the connection manager: The get-content function call includes two parameters: elements, which is optional, and view. The elements parameter can be composed of zero, one or more named elements, and/or segments. If no element parameter is supplied, then all content in the view(s) indicated is sent. The view parameter can contain one or more views, called “relationships” in the connection manager. The call returns content contained in the elements and element descriptors requested in the element parameter that are accessible with the relationship or relationships indicated in the view parameter. If an element is requested that is not available in the views accessed by the relationships, then the request is ignored.

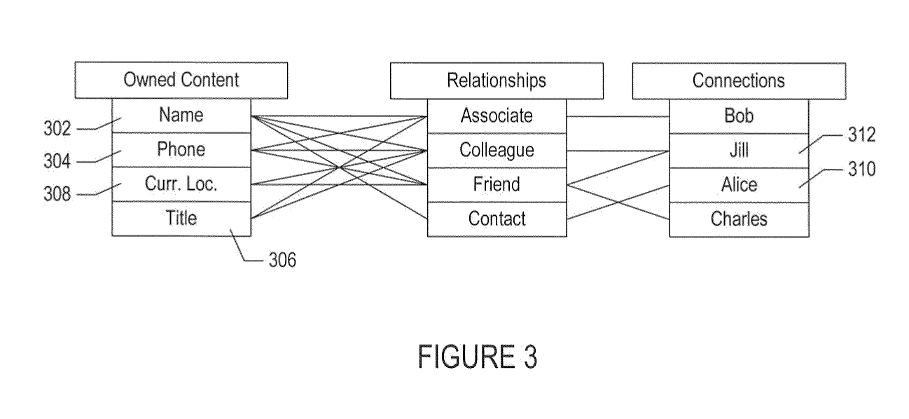

The connection manager stores and manages information about connections the agent service has with other online applications and relationships, or views, linking connections to the user's content. The connection manager has a user interface, can issue the get content function described in the content manager, and can receive the get connection content request from another agent service via the communication manager. The get connection content request includes the identifier of the sender, which is used to determine the relationships assigned to the connection. The get connection content request generates a get-content function call to the content manager and the results are passed to the communication manager. FIG. 3 shows accessibility of various types of information. FIG. 3 illustrates how “name” 302 is accessible to all relationships, “phone” 304 is available to friends, associates, and colleagues, “title” 306 to associates and colleagues, and “current location” 308 is accessible only to colleagues and friends. Since Alice 310 has been assigned the contact relationship, she has access, to only “name”. Jill 312, having relationships of friend and colleague has access to all the information.

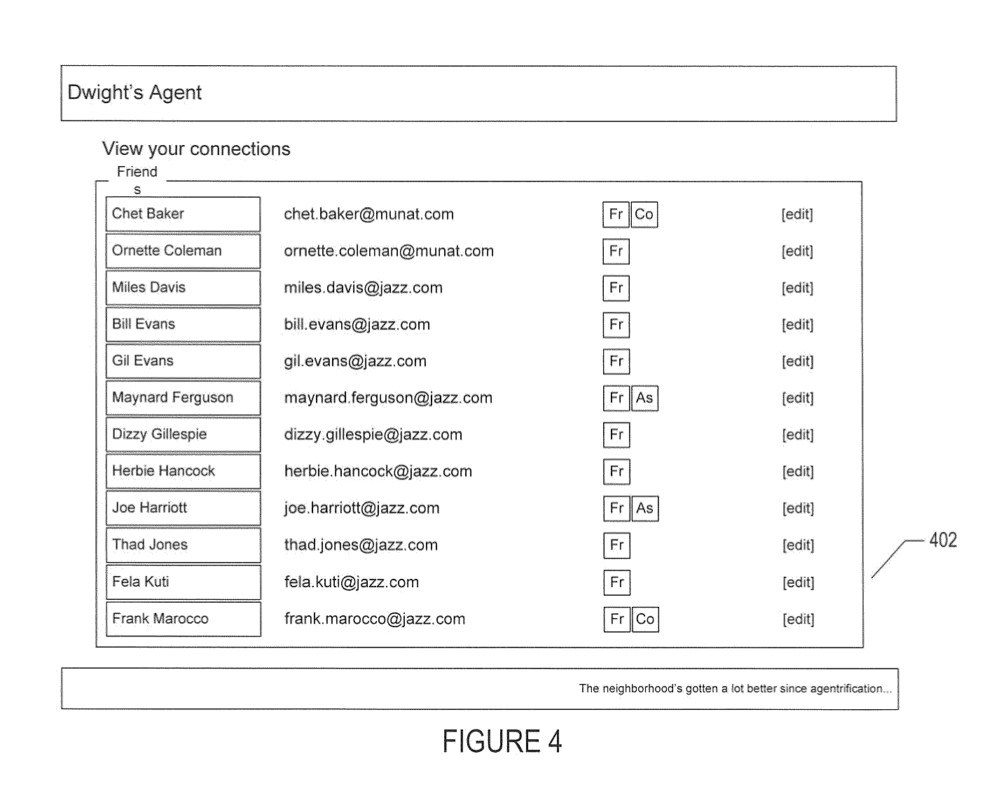

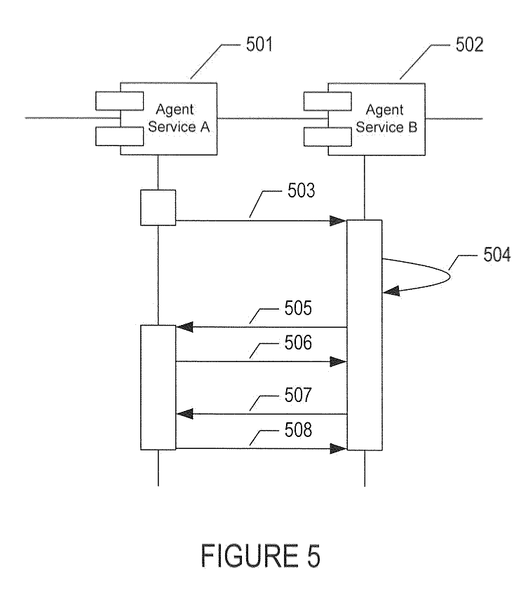

FIG. 4 shows how connections are associated to their relationships in the user interface. FIG. 4 shows a screen capture of a connections page 402. Relationships are assigned to contacts either through introductions or invitations. Introductions are described below under the agent connection section. Invitations are used to change the relationship or add a new one, and are described in FIG. 5. The user of agent service A 501 selects an option in the connection manager to send an invitation to agent service B 502 to either change to a different relationship or add a new one. For example, the owners of A and B share a relationship of “colleague,” but A's owner wants to invite B's: owner to a relationship of “friend” as well. Or as an alternate example, two Agents which are connected anonymously, meaning no personally identifiable information is accessible between them, may wish to allow each other to have access to their names and other personally identifiable information. In this case the invitation sent is to replace the shared “anonymous” relationship to “acquaintance” or “contact”. After selecting the contact, the new or additional relationship, and adding any comments, the owner of agent service A instructs agent service A to send the invitation. The state of the connection representing agent service B is changed to “invited to <relationship> and agent service A sends a message 503 to agent service B inviting the owner of agent service B to a new or additional relationship. The owner of agent service B reviews the invitation and either accepts or rejects it 504. The acceptance or rejection may also include comments added by agent service B's owner. If an acceptance is sent then the invitation state of agent service B's connection representation of A is changed to “provisionally accepted,” The acceptance or rejection is sent from B to A 505. If a rejection is sent, then fee invitation state of agent service's connection representing B is changed back to the default, “not invited.” If accepted, then agent service A changes the state, of the connection representing B to “provisionally accepted” and sends a message to B 506 confirming receipt: of the provisional acceptance. Upon receipt of the “provisionally accepted” message 506, agent service B changes the state of the connection representing A to the new or added relationship proposed by A and sends a confirmation 507 to A. A changes the state of the connection representing B to the new or added relationship and returns the invitation state of the connection representing B back to the default, and sends a confirmation to B 508. Upon receipt of the confirmation from A, B changes the initiation state of the connection representing A back to the default.

Connection information managed by the connection manager includes the data required to support agent connections and login information to connect to sites requiring a username and/or password. A connection can also represent an RSS feed. An RSS feed is set up by supplying the feed source with a Uniform Resource Identifier (URI) that the communication manager monitors and creating a connection in the connection manager with the URI of the source. Other connection information may be managed by the connection manager, such as annotations and aliases used with a connection, alternate communication methods, or encryption methods. Connection information is managed by the content manager, thus the content manager has the ability to allow connections access to a subset of connection information. The connection manger can be used to act as a personal “wailed garden,” since connections limit where messages can be sent to or received from, and when the agent service is used as a proxy by the user, what websites the user's browser can access.

The communication manager provides communications with other online applications and passes those communications to the connection manager or subscription manager. The communication manager can use agent connections to communicate with other compatible applications, can receive messages from other online applications, such as RSS feeds, and act as a proxy to the user's browser to log into sites and browse the Internet. The communication manager will only receive communications from known URFs from non agent connections, according to one embodiment of the present invention. When a message is received, the communication manager first checks to see if it is a standard agent connection message. An example of communications from a non agent connection is an RSS feed. If a non Agent connection then the communication manager checks the sending URI and makes a check connection function call to the connection manager with the origin URI as the only parameter to see if the URI corresponds to known connection. If the URI is from a known connection, then the message is passed to the subscription manager. If the connection is not known, then the subscription manager discards the message. A message from an agent connection contains the id associated with the agent connection in the header of the message. The id is used in a function call to the connection manager to obtain the key to decrypt the body of the message. The communication manager passes the key and the body of the message to the decryption algorithm, which returns the decrypted message. The communication manager passes the decrypted message to the subscription manager. To send a message to a connection using the agent connection, the communication manager uses the key to encrypt the message and then, sends the message with the identification to the network address. The connection manager may transmit over other protocols, use a specific encryption algorithm, or other variations, if non-default implementations are indicated by the agent connection. The default communication supported is HTTP over TCP/IP. Other protocols, such as asynchronous messaging, can also be supported. Each connection is independent, so the protocol and network used by one connection can be different from those used y another.

Two applications using the agent connection generally have an implementation using a common protocol on a common network, such as HTTP over the Internet. The agent connection stores state information and at least three pieces of data: an identification, a network address, and an encryption key. Additional information may include a protocol, an encryption algorithm, or any other information about the agent connection that is different from the default configuration. Agent connections are implemented in an agent service by the communication manager component. To send a message to a connection using the agent connection, the communication manager uses the key to encrypt the message and then sends the message with fee identification as a header to the network address. The communication manager may transmit over other protocols, use a specific encryption algorithm, or other variations, if non-default implementations are indicated by the agent connection. When a message is received by the communication manager, the identification included in the message is used to identify from which agent connection the message originates. The communication manager uses the key associated with the agent connection to decrypt the message.

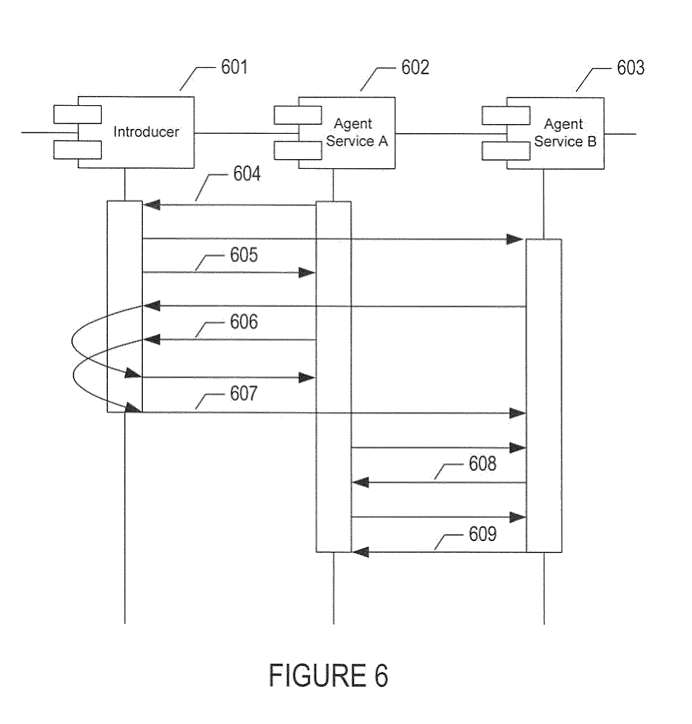

Keys are exchanged over a secure pathway to prevent them from being intercepted by other parties. In the implementation described below and in FIG. 6, the agent connections' key security is accomplished by using a common trusted third party to pass the initial connection information through a process called “an introduction.” Other secure methods of exchanging keys, such as; a physical exchange, are possible.

FIG. 6 illustrates the introduction process. A request-to-connect message 605 contains the id of the introducer 601 and the alias the requestor is known to the introducer 601. The request to connect results in a state change in the introducer 601 for each connection. Requests to connect come either from a request from another agent via normal messaging, or are initiated by the Introducer 601.

A conditional-acceptance, message 606 is sent by an to the Introducer 601. The Introducer 601 forwards 607 the message only if it has introduced the sender to the intended receiver. Introducer 601 changes state to “pending introduction” until both conditional acceptances are received. The agent sending the conditional acceptance creates a conditional connection with the id used by the other agent with the introducer 601. A conditional-acceptance message is received if there is a conditional connection, or a completed connection. The latter used to re-establish a connection, if it has broken. An accept-connection message 608—contains an id, the network address the sender wants the receiver to use to contact the sender, a key, and optionally a new encryption mechanism. An accept-connection message can occur when the connection is in a conditional acceptance state or completed state. The state changes to “completed” upon sending. If the state is pending when the accept-connection message is received, or die connection is in a completed state and one or more of id, address, or key has changed, then an accept-connection message is automatically resent 609. This resend may have a new id, key, and/or address. The accept-connection message is resent until it has been received twice in a row with no changes to id, key, or address. An introduction-denied message can be sent by one or both introduced agents with a freeform text for the introducer 601 to forward to the requesting Agent.

In FIG. 6, the introducer 601 has an agent connection to both A 602 and B 603 that was created by another introduction. The sequence of message exchange shown in FIG. 6 includes:
604. Agent A 602 requests the introducer 601 for an introduction to B 603 via normal messaging.
   No state changes.
605. The introducer 601 sends a request-to-connect message to A 602 and B 603. Introducer's 601 connection to A 602 and B 603 changes state to “pending introduction” to B 603 and A 602. Resend of message 605 will resend the Introduction to both—state remains “pending,” If the introduction is not approved, then introducer's 601 connections to A 602 and B 603 do not change state. The introducer 601 will only forward message 3 when it is in a pending or completed “introduced” state.
606. A 602 conditionally accepts by sending a conditional-acceptance message, which generates an id for B 603 and creates a key using the agent standard encryption mechanism and sends both to A 602 to the introducer 601. B 603 does the same. Introducer's 601 state remains the same. A 602 and B 603 create a pending connection to the other and assign a relationship to it. If B 603 does not accept the Introduction, then the introducer's 601 and A's 602 state remain as “pending,” Pending connections will only accept an accept-connection message.
607. The Introducer 601 forwards the information to the Agents. The state of the Introducer 601 connection to A 602 changes to “introduced to B” and visa versa.
608. The Agents then send each other an accept-connection message with new encryption keys and id assignments.
609. The Agents implement the new keys and resends accept-connection message, A's 602 connection to B 603 changes state to “connected.” If the accept-connection message is received by a completed connection rather than pending, then the agent's owner must approve the change to the connection. This may involve checking claims via customer services.
   Resend of the accept-connection message to a completed connection can be used in two scenarios.
   1 The agents' owners wish to implement a new security mechanism that requires new keys.
   2 One agent is being moved to a new network address or make any other changes to the agent connection.
   A conditional-acceptance can be resent through the introducer 601. This would be done in the event the connection between A 602 and B 603 is “broken”.
   Broken connections can occur when id's and/or keys are not changed properly. For example, message 607 is sent and message 608 was never received. In this case, agent initiating the change would still have the old id's/keys and the receiving Agent would have changed the id/keys.

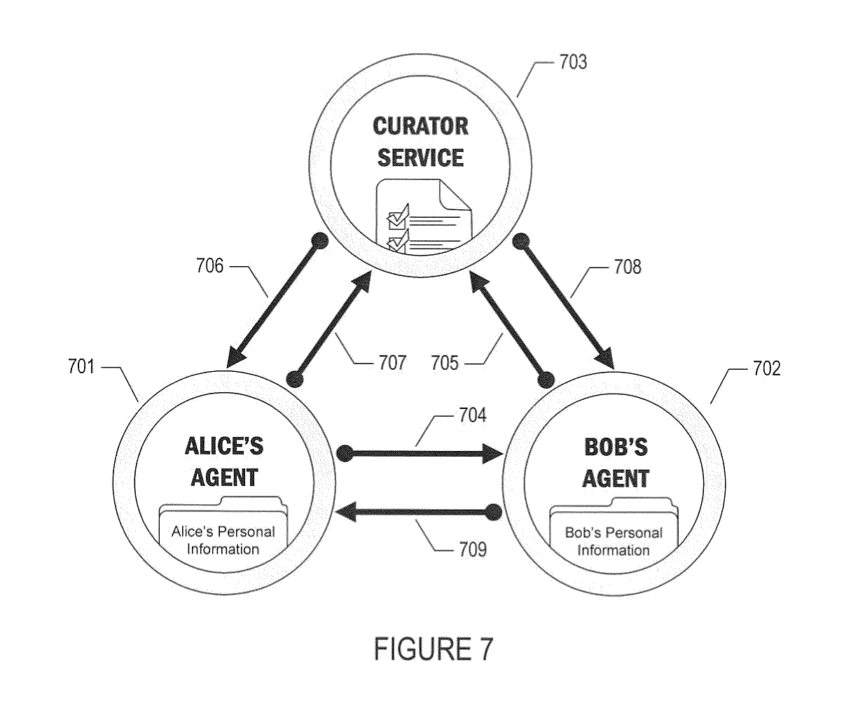

Any piece of data sent to an agent service can include a link to one or more third parties that will provide evidence of the veracity of the data. This data, or claim, can be about the identity of the sender or some fact about the sender or any other subject that the receiver may use to act in a trusting manner, such as the ability to pay a specified amount. The third party, here called a customer service, will provide the evidence of a claim if the claimant authorizes any check on the claim. Evidence can be provided with further evidence to support the authority of the provider of the original evidence, thus forming a web of provenance. The most basic form of the web of provenance is the “ternary conversation” and is illustrated in FIG. 7 as follows:
(704) The claimant 701 makes a claim, such as “I will transfer $500 to you in return for this camera”, to an entity he or she believes is authentic 702, such as a clerk in a store. Tire claim includes an identification of a customer service 703, such as a bank and some unique code which the claimant and the customer service 703 agree to as a means to identify the claimants. This code may be unique to this transaction or re-used. The difference between this code and, for example, a credit card number, is that the code does not have to be kept secret, since it is useless to anyone but the claimant.
(705) The recipient 702 contacts the customer service 703 with the code and the amount to verify that the claim that they will get paid $500 is valid.
(706) The customer service 703 uses the code to determine who the claimant is and contacts the claimant 701 to confirm the amount.
(707) The claimant 701 grants permission to the customer service 703 to verify the claim.
(708) The customer service 703 provides evidence to support the claim to the recipient 702.
(709) The recipient 702 gives the response the camera that the claimant 701 desires.

For financial transactions, such as the one in this example, the recipient the clerk may also pass fund transfer information to the customer service the bank to receive the funds. In a modified scenario, instead of contacting the claimant's customer service bank A directly, the recipient clerk contacts the store's customer service bank B, which has a secure, authenticated connection with the recipient's customer service bank A. The two customer services manage the validation of the claim and transfer of funds. Other examples of the web of provenance being used for what could be considered sensitive information validation include credit checks, employment verification, personal references, and health information. A significant capability of the web of provence is the ability to make claims without, providing any identity information. In the above example, the claimant does not have to provide any personal or financial information to the recipient to execute the transaction. The recipient, or anyone else, cannot use any of the information supplied by the claimant to execute transactions without the claimant's knowledge. Verified-anonymous is the term used to identify the ability to make a verifiable, claim without providing identity in formation.

A minimal customer service contains a number of components. One component is a secure website that can be altered by authorized individuals. Another component is a data store that can be accessed by the website, but altered only by authorized individuals. The data store contains, at a minimum, an identifier the code for the claimant that the claimant can use to validate claims and information on how to connect to the claimant to approve claim checks. If an agent connection is being used, then the minimal connection information stored is a network address and a key used to encrypt messages sent to the claimant and the key used to decrypt messages from the claimant. A method for recipients of claims to reliably identify the reference website and its owner and communicate in a secure manner. An example of this is obtaining a certificate from a certificate authority and communicating with the recipient over HTTPS. Another component is an interface to enter data securely. Tire minimal amount of data is the code passed from the claimant to the recipient. The interface may be accessed via a browser for manual entry, and/or electronically via an EDI transaction, reliable store and forward mechanisms, such as RabbitMQ, SOAP message, or any standard, message structure, through a secure channel.

Although the present invention has been described in terms of particular embodiments, it is not intended that the invention be limited to these embodiments. Modifications will be apparent to those skilled in the art. For example, agent services that represent embodiments of the present invention can be implemented in any of many different computer languages for use in many different electronic devices and systems by varying any of many implementation parameters, including operating-system platform, data structures, modular organization, control structures, and other such implementation parameters.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended, to be exhaustive or to limit the invention to the precise forms disclosed. Many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. An agent service, implemented as an autonomous software application, that:
establishes and maintains trusted connections; and
differentially controls access to digital property.
